(19) United States
(12) Patent Application Publication
(10) Pub. No.: US 2019/0082482 A1
(43) Pub. Date: Mar. 14, 2019

(54) RESOURCE ACCESS METHOD, APPARATUS, AND SYSTEM

(71) Applicant: HUAWEI TECHNOLOGIES CO., LTD., Shenzhen (CN)

(72) Inventor: Huadong CHEN, Shenzhen (CN)

(21) Appl. No.: 16/186,388

(22) Filed: Nov. 9, 2018

Related U.S. Application Data
(63) Continuation of application No. PCT/CN2016/081913, filed on May 12, 2016.

(51) Int. Cl. H04W 76/12; H04W 72/04; H04L 29/12

(52) U.S. Cl. CPC H04W 76/12; H04W 88/02; H04L 61/2007; H04W 72/04

(57) ABSTRACT

A resource access method and an apparatus are provided, to improve resource access efficiency. The method includes: receiving, by a base station, an IP packet of first UE, where the IP packet carries an IP address of a target server, the target server stores a resource to be accessed by the first UE, and there is a bearer, corresponding to the first UE, between the base station and a first packet gateway through a serving gateway; determining, by the base station based on the IP address, a first target gateway corresponding to the target server; determining a first target tunnel between the base station and the first target gateway; and sending, by the base station, an access request of the first UE to the first target gateway through the first target tunnel, where the access request is used to request to access the resource stored in the target server.

### CROSS-REFERENCE TO RELATED APPLICATIONS

This application is a continuation of International Application No. PCT/CN2016/081913, filed on May 12, 2016, the disclosure of which is hereby incorporated by reference in its entirety.

### TECHNICAL FIELD

The present invention relates to the field of communications technologies, and in particular, to a resource access method, an apparatus, and a system.

### BACKGROUND

In the prior art, with development of a Long Term Evolution (Long Term Evolution, LTE) system, cache servers are deployed on edge gateways at various locations in a content delivery network (Content Delivery Network, CDN), and the cache server may cache a resource in a remote server. Through scheduling of a center platform, user equipment (User Equipment, UE) may obtain a resource from a nearby edge cache server of the edge cache servers at various locations. Usually, the UE accesses an external network through a base station, a serving gateway (Serving Gateway, SGW), and a packet data network gateway (Packet Data Network Gateway, PGW). In a case of a single packet data network (Packet Data Network, PDN) connection, the UE accesses the external network through a PGW (for example, a PGW1). When a resource that needs to be accessed by the UE is stored in a server deployed on another PGW (for example, a PGW2) other than the PGW1, the PGW1 needs to be connected to the PGW2, and obtains the resource from the PGW2, and then the PGW1 sends the resource to the UE. This resource access path causes route recurvation, and is unfavorable to the UE for obtaining a resource.

### SUMMARY

The present invention provides a resource access method, a base station, a gateway, a packet gateway, and a system, so as to improve resource access efficiency.

According to one aspect, an embodiment of the present invention provides a resource access method, and the method includes: receiving, by a base station, an IP packet of first UE, where the IP packet carries an IP address of a target server, the target server stores a resource to be accessed by the first UE, and there is a bearer, corresponding to the first UE, between the base station and a first packet gateway; determining, by the base station based on the IP address, a first target gateway corresponding to the target server; determining, by the base station, a first target tunnel between the base station and the first target gateway; and sending, by the base station, an access request of the first UE to the first target gateway through the first target tunnel, where the access request is used to request to access the resource stored in the target server. According to the solution provided in this embodiment of the present invention, when there is the bearer, corresponding to the UE, between the base station and the first packet gateway, a target tunnel is determined between the base station and the first target gateway, so that the UE can access the resource in the target server corresponding to the first target gateway through the target tunnel, so as to reduce route recurvation of an access path, and improve resource access efficiency.

In a possible design, the first target tunnel between the base station and the first target gateway may be determined in one of the following manners. In a first manner, the base station establishes the first target tunnel between the base station and the first target gateway. In a second manner, the base station determines the first target tunnel from the at least one existing tunnel, and the at least one existing tunnel is a tunnel, corresponding to the UE, between the base station and at least one gateway. Therefore, when there is the tunnel, corresponding to the UE, between the base station and the at least one gateway, the tunnel may be directly determined as the first target tunnel, so as to save resources.

In a possible design, the base station receives uplink data sent by second UE to a second target gateway, where the base station is a target base station to which the second UE is to be handed over from a source base station, there is a tunnel, corresponding to the second UE, between the source base station and the second target gateway, and there is a bearer, corresponding to the second UE, between the source base station and a second packet gateway. When establishment of a tunnel is not supported between the base station and the second target gateway, the base station transmits the uplink data to the second target gateway through the second packet gateway; or when establishment of a tunnel is supported between the base station and the second target gateway, the base station determines a second target tunnel between the base station and the second target gateway, so that the uplink data is transmitted to the second target gateway through the second target tunnel. According to the method provided in this embodiment of the present invention, as the target base station to which the UE is to be handed over, the base station determines, after receiving uplink data sent by the UE to a target gateway, whether establishment of a tunnel is supported between the base station and the second target gateway, and determines, based on a determining result, whether the tunnel is established between the base station and the second target gateway.

In a possible design, the base station is a source base station, and the first target gateway receives a first uplink data packet sent by the first UE through a target tunnel. The first target gateway receives a second uplink data packet sent by the first UE through a second base station. When a 5-tuple of the first uplink data packet is the same as a 5-tuple of the second uplink data packet, the first target gateway determines that the first UE is handed over from the source base station to the second base station. The first target gateway transmits downlink data to the first UE through a tunnel between the second base station and the first target gateway, or the first target gateway transmits downlink data to the first UE through the first packet gateway.

In a possible design, the base station receives an end marker sent by the first target gateway, so as to terminate a connection, corresponding to the first UE, between the base station and the first target gateway. Therefore, when the UE is handed over from the base station to another base station, the resource occupied by the UE may be released in a timely manner.

In a possible design, the target gateway sends, to the first packet gateway, charging information that is generated when the UE accesses the resource, and the charging information is used by the first packet gateway to perform charging. Therefore, according to the solution in this embodiment of the present invention, operations of the target gateway can be simplified.

In a possible design, a dedicated bearer corresponding to the UE may be further established between the first packet gateway and the target gateway. For example, the target gateway may send a dedicated bearer establishment request to the first packet gateway, and the dedicated bearer establishment request is used to request to establish a first dedicated bearer, corresponding to the UE, between the target gateway and the first packet gateway. After receiving the dedicated bearer establishment request, the first packet gateway establishes the first dedicated bearer based on the dedicated bearer establishment request, and the first packet gateway determines a second dedicated bearer between the first packet gateway and the UE. Further, the first packet gateway may determine the second dedicated bearer with the UE in the following manner: The first packet gateway determines that there is a dedicated bearer between the first packet gateway and the UE, and determines the dedicated bearer as the second dedicated bearer; or the first packet gateway determines that there is no dedicated bearer between the serving gateway and the UE, and establishes the second dedicated bearer. Another bearer does not need to be established, so that utilization of a bearer resource may be improved, thereby saving network resources.

In a possible design, a dedicated bearer between the first packet gateway and the target gateway may be further modified. For example, the first packet gateway receives a dedicated bearer modification request sent by the target gateway, and the dedicated bearer modification request is used to request to modify the first dedicated bearer. The first packet gateway modifies the first dedicated bearer based on the dedicated bearer modification request. The first packet gateway determines that there is a dedicated bearer, corresponding to the UE, between the first packet gateway and another gateway other than the target gateway, and the first packet gateway establishes a new dedicated bearer between the first packet gateway and the UE. When modifying the first dedicated bearer with the target gateway, the first packet gateway determines that there is the dedicated bearer, corresponding to the UE, between the first packet gateway and the another gateway other than the target gateway, in other words, the target gateway shares a second dedicated bearer with the another gateway, and the first packet gateway establishes the new dedicated bearer between the first packet gateway and the UE, so as to ensure communication of the dedicated bearer between the UE and the another gateway, and improve resource access efficiency.

In a possible design, a first dedicated bearer between the first packet gateway and the target gateway may be further deleted. For example, the first packet gateway receives a dedicated bearer deletion request sent by the target gateway, and the dedicated bearer deletion request is used to request to delete the first dedicated bearer. The first packet gateway deletes the first dedicated bearer based on the dedicated bearer deletion request. The first packet gateway determines that there is no dedicated bearer, corresponding to the UE, between the first packet gateway and another gateway other than the target gateway, and deletes the second dedicated bearer. When deleting the first dedicated bearer with the target gateway, the first packet gateway determines whether there is a dedicated bearer, corresponding to the UE, between the first packet gateway and the another gateway. When there is the dedicated bearer, the first packet gateway does not delete a dedicated bearer between the first packet gateway and the UE, so as to ensure normal communication of the dedicated bearer between the UE and the another gateway.

In the foregoing method example, the target server may be a service server, or may be a cache server. The target gateway may be located in a same node as the target server.

In the foregoing method example, the serving gateway may be an SGW or a serving general packet radio service support node (Serving General Packet Radio Service Support Node, SGSN), and the first packet gateway may be a packet data network gateway PGW or a gateway general packet radio service support node (Gateway General Packet Radio Service Support Node, GGSN).

According to another aspect, an embodiment of the present invention provides a base station, and the base station has a function of implementing base station behavior in the foregoing method design. The function may be implemented by hardware, or may be implemented by hardware by executing corresponding software. The hardware or the software includes one or more modules corresponding to the foregoing function.

In a possible design, a structure of the base station includes a processing unit and a communications unit, and the processing unit is configured to support the base station in performing corresponding functions in the foregoing method. The communications unit is configured to support communication between the base station and another device. The base station may further include a storage unit, and the storage unit is configured to be coupled to the processing unit and store a program instruction and data that are necessary for the base station. In an example, the processing unit may be a processor, the communications unit may be a communications interface, and the storage unit may be a memory.

According to still another aspect, an embodiment of the present invention provides a gateway, the gateway may be referred to as a target gateway, and the target gateway has a function of implementing target gateway behavior in the foregoing method design. The function may be implemented by hardware, or may be implemented by hardware by executing corresponding software. The hardware or the software includes one or more modules corresponding to the foregoing function.

In a possible design, a structure of the target gateway includes a processing unit and a communications unit, and the processing unit is configured to support the target gateway in performing corresponding functions in the foregoing method. The communications unit is configured to support communication between the target gateway and another device. The target gateway may further include a storage unit. The storage unit is configured to be coupled to the processing unit and store a program instruction and data that are necessary for the target gateway. In an example, the processing unit may be a processor, the communications unit may be a communications interface, and the storage unit may be a memory.

According to still another aspect, an embodiment of the present invention provides a packet gateway, the packet gateway may be referred to as a first packet gateway, and the first packet gateway has a function of implementing first packet gateway behavior in the foregoing method design. The function may be implemented by hardware, or may be implemented by hardware by executing corresponding software. The hardware or the software includes one or more modules corresponding to the foregoing function.

In a possible design, a structure of the first packet gateway includes a processing unit and a communications unit, and the processing unit is configured to support the first packet gateway in performing corresponding functions in the foregoing method. The communications unit is configured to support communication between the first packet gateway and another device. The first packet gateway may further include a storage unit. The storage unit is configured to be coupled to the processing unit and store a program instruction and data that are necessary for the first packet gateway. In an example, the processing unit may be a processor, the communications unit may be a communications interface, and the storage unit may be a memory.

According to still another aspect, an embodiment of the present invention provides a communications system, and the system includes the base station and the target gateway according to the foregoing aspects, or the system includes the base station, the target gateway, and the first packet gateway according to the foregoing aspects.

According to yet another aspect, an embodiment of the present invention provides a computer storage medium, configured to store a computer software instruction used by the foregoing base station, and the computer storage medium includes a program designed for executing the foregoing aspects.

According to yet another aspect, an embodiment of the present invention provides a computer storage medium, configured to store a computer software instruction used by the foregoing target gateway, and the computer storage medium includes a program designed for executing the foregoing aspects.

According to yet another aspect, an embodiment of the present invention provides a computer storage medium, configured to store a computer software instruction used by the foregoing first packet gateway, and the computer storage medium includes a program designed for executing the foregoing aspects.

Compared with the prior art, according to the solutions provided in the embodiments of the present invention, when there is a bearer, corresponding to the UE, between the base station and the first packet gateway, after receiving the IP packet of the UE, the base station may determine, based on the IP address of the target server carried in the IP packet, the first target gateway corresponding to the target server, determine a target tunnel, corresponding to the UE, between the base station and the first target gateway, and transmit an access request of the UE through the target tunnel, where the access request is used to request to access a resource stored in the target server. Therefore, according to the solutions provided in the embodiments of the present invention, route recurvation of an access path can be avoided, so as to improve resource access efficiency of the UE.

### BRIEF DESCRIPTION OF DRAWINGS

To describe the technical solutions in the embodiments of the present invention more clearly, the following briefly describes the accompanying drawings required for describing the embodiments of the present invention. Apparently, the accompanying drawings in the following description show merely some embodiments of the present invention, and a person of ordinary skill in the art may still derive other drawings from these accompanying drawings without creative efforts.

FIG. 1 is a schematic diagram of a possible application scenario according to an embodiment of the present invention;

FIG. 2 is a schematic diagram of a possible system architecture applied to an embodiment of the present invention;

FIG. 3 is a schematic flowchart of a resource access method according to an embodiment of the present invention;

FIG. 4 is a schematic diagram of communication of another resource access method according to an embodiment of the present invention;

FIG. 5 is a schematic diagram of communication of still another resource access method according to an embodiment of the present invention;

FIG. 6 is a schematic diagram of communication of a dedicated bearer establishment method according to an embodiment of the present invention;

FIG. 7 is a schematic diagram of communication of a dedicated bearer modification method according to an embodiment of the present invention;

FIG. 8 is a schematic diagram of communication of a dedicated bearer deletion method according to an embodiment of the present invention;

FIG. 9A is a schematic structural diagram of a base station according to an embodiment of the present invention;

FIG. 9B is a schematic structural diagram of another base station according to an embodiment of the present invention;

FIG. 10A is a schematic structural diagram of a gateway according to an embodiment of the present invention;

FIG. 10B is a schematic structural diagram of another gateway according to an embodiment of the present invention;

FIG. 11A is a schematic structural diagram of a packet gateway according to an embodiment of the present invention; and

FIG. 11B is a schematic structural diagram of another packet gateway according to an embodiment of the present invention.

### DESCRIPTION OF EMBODIMENTS

To make the purpose, technical solutions, and advantages of the embodiments of the present invention clearer, the following describes the technical solutions of the embodiments of the present invention with reference to the accompanying drawings in the embodiments of the present invention.

Network architectures and service scenarios described in the embodiments of the present invention are intended to more clearly describe the technical solutions in the embodiments of the present invention, but are not intended to limit the technical solutions provided in the embodiments of the present invention. A person of ordinary skill in the art may know that as the network architectures evolve and a new service scenario emerges, the technical solutions provided in the embodiments of the present invention are further applicable to a similar technical problem.

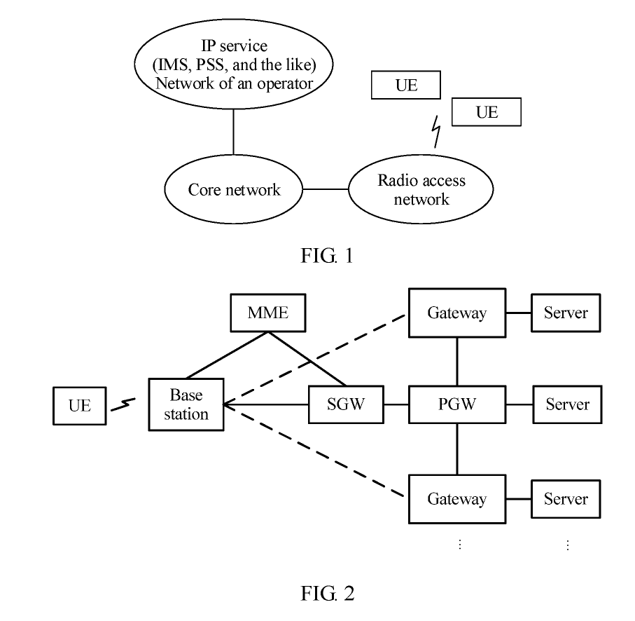

As shown in FIG. 1, UE accesses an operator Internet Protocol (Internet Protocol, IP) service network such as an IP multimedia subsystem (IP Multimedia System, IMS) network and a packet-switched streaming service (Packet-Switched Streaming Service, PSS for short) network through a radio access network (Radio Access Network, RAN) and a core network (Core Network, CN). The technical solutions described in the embodiments of the present invention may be applied to a Long Term Evolution (Long Term Evolution, LTE) system or other wireless communications systems that use various radio access technologies, for example, systems that use access technologies such as Code Division Multiple Access (Code Division Multiple Access, CDMA), Frequency Division Multiple Access (Frequency Division Multiple Access, FDMA), Time Division Multiple Access (Time Division Multiple Access, TDMA), Orthogonal Frequency Division Multiple Access (Orthogonal Frequency Division Multiple Access, OFDMA), and Single Carrier Frequency Division Multiple Access (Single Carrier Frequency Division Multiple Access, SC-FDMA). In addition, the technical solutions may be applied to a subsequent evolved system of the LTE system, for example, a 5th generation (5th Generation, 5G) system. For clarity, herein, only the LTE system is used as an example for description. In the LTE system, an evolved universal terrestrial radio access network (Evolved Universal Terrestrial Radio Access Network, E-UTRAN) is used as a radio access network, and an evolved packet core (Evolved Packet Core, EPC) is used as a core network. The UE accesses the IMS network through the E-UTRAN and the EPC.

In the embodiments of the present invention, nouns “network” and “system” are often interchangeably used, but meanings of the nouns can be understood by a person skilled in the art. The user equipment UE used in the embodiments of the present invention may include various handheld devices, in-vehicle devices, wearable devices, and computing devices that have a wireless communication function, or other processing devices connected to a wireless modem, and various forms of user equipments (User Equipment, UE), mobile stations (Mobile station, MS), terminals (terminal), terminal devices (terminal device), and the like. For ease of description, in the embodiments of the present invention, the devices mentioned above are collectively referred to as user equipment or UE. A base station (Base station, BS) used in the embodiments of the present invention is an apparatus that is deployed in a radio access network and that is configured to provide a wireless communication function for the UE. The base station may include a macro base station, a micro base station, a relay station, an access point, and the like in various forms. In systems that use different radio access technologies, devices with a base station function may have different names. For example, in the LTE network, the device with a base station function is referred to as an evolved NodeB (evolved NodeB, eNB or eNodeB); and in a 3rd generation (3rd Generation, 3G) network, the device with a base station function is referred to as a NodeB (NodeB), and so on. For ease of description, in the embodiments of the present invention, the foregoing apparatuses that provide the wireless communication function for the UE are collectively referred to as the base station or the BS.

FIG. 2 is a schematic diagram of a possible system architecture according to an embodiment of the present invention. As shown in FIG. 2, UE accesses an SGW through a base station, and accesses a PGW through the SGW. A mobility management entity (Mobility Management Entity, MME) is used as a control-plane network element, and is separately connected to the base station and the SGW through a port, and the MME is configured to transmit control-plane signaling to the base station and the SGW. In addition, the system architecture shown in FIG. 2 further includes another gateway. A local server is usually deployed on the PGW and each gateway. For example, the local server may be a cache server (cache server) or a service server that is deployed on a same node as a corresponding PGW or gateway. The foregoing another gateway may be a packet gateway, or may be a lightweight gateway. The lightweight gateway may be a gateway having data routing and forwarding functions. For example, the lightweight gateway may include no charging function. The lightweight gateway may send, to the PGW, charging information that is generated when the UE accesses a resource through the lightweight gateway, and the PGW performs charging. It should be noted that FIG. 2 is merely an example. When the solution in this embodiment of the present invention is applied to a network architecture of a 2nd generation (2nd Generation, 2G) communications system or a 3G communications system, a function of the SGW may be completed by an SGSN, and a function of the PGW may be completed by a GGSN.

In the prior art, a bearer corresponding to UE is established between an SGW and a PGW1. When accessing a network resource, the UE may first query whether a local server corresponding to the PGW1 stores the resource. When the local server stores the resource, the UE may obtain the resource from the local server nearby, so as to avoid network congestion, and improve a response speed when a user accesses the resource. When the local server corresponding to the PGW1 does not store the resource, the PGW1 may query whether another local server stores the resource. When the another local server (for example, a local server corresponding to a PGW2) stores the resource, the PGW1 may establish a bearer with the PGW2 corresponding to the another local server, to obtain the resource. However, when the PGW1 obtains the resource by establishing the bearer with the PGW2, a path for obtaining the resource is roundabout, and consequentially an access speed of the UE is affected, and it is unfavorable to saving network resources.

Based on this, an embodiment of the present invention provides a resource access method, and a main idea of the method is that in a single PDN connection, a base station establishes a bearer with a default packet gateway through a serving gateway, and may further establish a tunnel corresponding to same UE with at least one another gateway, so as to help UE obtain a resource. For example, the method may include: receiving, by the base station, an IP packet of the UE, where the IP packet carries an IP address of a target server, the target server stores a resource to be accessed by the UE, and there is a bearer, corresponding to the UE, between the base station and a first packet gateway; determining, by the base station based on the IP address, a target gateway corresponding to the target server; determining, by the base station, a target tunnel between the base station and the target gateway, where, for example, the base station may establish the target tunnel, or select the target tunnel from an existing tunnel; and sending, by the base station, an access request of the UE to the target gateway through the target tunnel, where the access request is used to request to access the resource stored in the target server. Correspondingly, after receiving the access request of the UE that is sent by the base station through the target tunnel, the target gateway may transmit the resource to the UE through the target tunnel. According to the solution provided in this embodiment of the present invention, after receiving the access request of the UE, the base station may send the access request of the UE to the target gateway through the target tunnel, so as to access the resource stored in the target server corresponding to the target gateway, thereby avoiding route recurvation of an access path, helping improve an access speed and efficiency of the UE, and saving network resources.

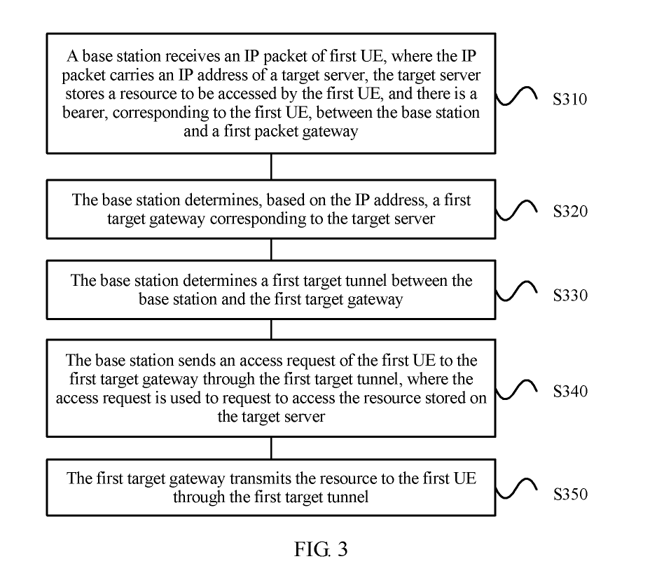

The following describes the solution in this embodiment of the present invention with reference to FIG. 3. FIG. 3 shows a resource access method 300 according to an embodiment of the present invention. As shown in FIG. 3, the method 300 includes the following steps.

S310. A base station receives an IP packet of first UE, where the IP packet carries an IP address of a target server, the target server stores a resource to be accessed by the first UE, and there is a bearer, corresponding to the first UE, between the base station and a first packet gateway.

The bearer between the base station and the first packet gateway may include two parts: a bearer between the base station and a serving gateway and a bearer between the serving gateway and the first packet gateway.

For example, the IP packet may be a Transmission Control Protocol (Transmission Control Protocol, TCP) establishment request packet, or the IP packet may be an IP packet in another format.

In an example, before sending the IP packet to the base station, the UE may further obtain the IP address of the target server. For example, the UE may receive the IP address of the target server sent by the first packet gateway. The first packet gateway may send a redirection message (for example, an HTTP redirection message) to the UE, and the redirection message includes the IP address of the target server.

In another example, the bearer between the base station and the first packet gateway may be a default bearer that is established between the UE and the first packet gateway when the UE establishes a PDN connection to a core network. The default bearer is accordingly established when the PDN is established, and the default bearer always exists when the PDN connection persists.

S320. The base station determines, based on the IP address, a first target gateway corresponding to the target server.

In an example, the base station may determine the target server based on the IP address, and then determine the first target gateway corresponding to the target server. The determining a first target gateway may be determining an IP address of the first target gateway. The first target gateway may be a gateway that is deployed on a same node as the target server, or the first target gateway may be a gateway that is located in a same local area network (Local Area Network, LAN) as the target server. A target gateway may be a packet gateway or the above described lightweight gateway. For example, the first target gateway may have no charging function, but may send, to the first packet gateway, charging information that is generated when the UE accesses the target server, and the first packet gateway performs charging.

S330. The base station determines a first target tunnel between the base station and the first target gateway.

In an example, that the base station determines the first target tunnel between the base station and the first target gateway may be that the base station determines the first target tunnel from at least one existing tunnel, and the at least one existing tunnel is a tunnel, corresponding to the UE, between the base station and at least one gateway.

In another example, the base station may establish the first target tunnel between the base station and the first target gateway. For example, the base station may establish the first target tunnel based on address information of the first target gateway and quality of service (Quality of Service, QoS) information carried in a service corresponding to the first UE. The address information of the first target gateway may be the IP address of the first target gateway. The first target tunnel may be a Generic Routing Encapsulation (Generic Routing Encapsulation, GRE) protocol tunnel, or may be a general packet radio service (General Packet Radio Service, GPRS) Tunneling Protocol-User Plane (GPRS Tunneling Protocol-User Plane, GTP-U) tunnel, or another type of tunnel.

S340. The base station sends an access request of the first UE to the first target gateway through the first target tunnel, where the access request is used to request to access the resource stored in the target server.

In an example, the access request may include the IP address of the target server, and the base station may determine or select, based on an IP address in the access request, a target tunnel to transmit an access request of the UE.

S350. The first target gateway transmits the resource to the first UE through the first target tunnel.

In an example, the first target gateway may further send, to the first packet gateway, charging information that is generated when the UE accesses the resource, and the charging information is used by the first packet gateway to perform charging. Therefore, according to the solution in this embodiment of the present invention, operations of the first target gateway may be simplified.

It should be noted that the bearer between the base station and the first packet gateway may be a part of a bearer that is corresponding to the UE and that is established by the UE through the base station, the serving gateway, and the first packet gateway. It may be understood that, when the UE sends a request message to the first packet gateway through the base station by using the bearer, or the UE sends a request message to the first target gateway through the base station by using the target tunnel, a bearer between the UE and the base station may be reused, thereby improving utilization efficiency of the bearer.

It may be understood that the bearer between the base station and the first packet gateway and the target tunnel are corresponding to a same PDN connection. Alternatively, it may be understood that according to the solution provided in this embodiment of the present invention, connections between a base station and a plurality of gateway anchors may be implemented on a same PDN connection. For example, in an LTE system, the connections between the base station and the plurality of gateway anchors may be implemented.

It should be noted that, in the prior art, on the single PDN connection, the base station can establish a connection corresponding to the UE to only a serving gateway and a packet gateway on a same path. When the resource accessed by the UE is located in a local server corresponding to another local gateway, the base station does not support establishment of a connection corresponding to the UE to another gateway based on a same PDN connection, and consequently, resource obtaining efficiency is affected. In this embodiment of the present invention, when there is the bearer, corresponding to the UE, between the base station and the first packet gateway, a target tunnel is determined between the base station and the first target gateway, so that the UE can access the resource in the target server corresponding to the first target gateway through the target tunnel, so as to reduce route recurvation of an access path, and improve resource access efficiency.

The solution in this embodiment of the present invention may further include at least one of the following optional solutions. It should be noted that these optional solutions may be performed based on the method shown in FIG. 3, or may not be performed based on the method shown in FIG. 3.

Optional solution 1: a solution of accessing a resource by UE when the UE is handed over between different base stations.

In an example, the solution in this embodiment of the present invention is described by using an example of second UE, and the second UE and the first UE may be same UE, or may be different UEs. When the second UE and the first UE are the same UE, a second target gateway in the following may be the first target gateway. When the second UE is handed over between two base stations (for example, a first base station and a third base station), the first base station may be a target base station, and the third base station may be a source base station. For example, the first base station may be the base station in the method shown in FIG. 3. There is a tunnel, corresponding to the second UE, between the third base station and the second target gateway, and there is a bearer, corresponding to the second UE, between the third base station and a second packet gateway. Certainly, the second packet gateway corresponding to the third base station and the first packet gateway corresponding to the first base station may be a same packet gateway.

In this example, the first base station may receive uplink data sent by the second UE to the second target gateway. When establishment of a tunnel is not supported between the first base station and the second target gateway, the first base station may transmit the uplink data to the second target gateway through the second packet gateway; or when the first base station determines that establishment of a tunnel is supported between the first base station and the second target gateway, the first base station may determine a second target tunnel between the first base station and the second target gateway, so that the uplink data is transmitted to the second target gateway through the second target tunnel.

For example, the second UE may establish a connection to the third base station. There is a second target tunnel, corresponding to the second UE, between the third base station and the second target gateway, and there is the bearer, corresponding to the second UE, between the third base station and the second packet gateway. When handover occurs, for example, when the second UE is handed over from the third base station to the first base station, the first base station receives the uplink data sent by the second UE to the second target gateway, and the first base station may determine whether establishment of a tunnel is supported between the first base station and a target gateway. When establishment of a tunnel is not supported between the first base station and the second target gateway, the first base station may send the uplink data to a serving gateway, so that the uplink data is transmitted to the second target gateway through the serving gateway and the second packet gateway (in other words, the uplink data is transmitted by using a default bearer); or when establishment of a tunnel is supported between the first base station and the second target gateway, the first base station may determine the second target tunnel between the first base station and the second target gateway, so that the uplink data is transmitted to the second target gateway through the second target tunnel.

In this example, the second target gateway may send an end marker to the third base station, so as to terminate a connection, corresponding to the second UE, between the third base station and the second target gateway. To be specific, after the second UE is handed over from the third base station to the first base station, the connection related to the second UE on a third base station side may terminate, so as to release the resource.

In this example, as the target base station to which the second UE is to be handed over, the first base station determines, after receiving the uplink data sent by the second UE to the second target gateway, whether establishment of a tunnel is supported between the first base station and the second target gateway, and determines, based on a determining result, whether to establish a tunnel between the first base station and the target gateway, so as to improve resource access efficiency.

In another example, when the UE is handed over between different base stations (for example, a first base station and a second base station), the solution in this embodiment of the present invention is described by using an example in which the first base station is a source base station, and the second base station is a target base station. For example, the first base station may be the base station in the method shown in FIG. 3. The UE may be the first UE, the second UE, or any other UE.

In this example, a target gateway (for example, the first target gateway) may receive a first uplink data packet sent by the UE through a target tunnel (for example, the first target tunnel), and receive a second uplink data packet sent by the UE through the second base station. When a 5-tuple of the first uplink data packet is the same as a 5-tuple of the second uplink data packet, the target gateway may determine that the UE is handed over from the first base station to the second base station. The target gateway may transmit downlink data to the UE through a tunnel between the second base station and the target gateway, or the target gateway may transmit the downlink data to the UE through the first packet gateway.

In a possible manner, the target gateway simultaneously receives uplink data packets sent by the UE on two paths, for example, the first uplink data packet sent by the UE through a first target tunnel between the first base station and the target gateway and the second uplink data packet sent by the UE through the second base station (for example, the second uplink data packet sent by the UE through the tunnel between the second base station and the target gateway, or the second uplink data packet sent by the UE to the target gateway through the second base station, a serving gateway, and the first packet gateway). The target gateway may determine whether the 5-tuple of the first uplink data packet is the same as the 5-tuple of the second uplink data packet. When the 5-tuple of the first uplink data packet is the same as the 5-tuple of the second uplink data packet, the target gateway may determine that the base station is switched from the first base station to the second base station. Then, the target gateway may send the downlink data to the UE through the tunnel between the target gateway and the second base station or through the first packet gateway (for example, by using a bearer among the first packet gateway, the serving gateway, and the second base station). In this example, the target gateway may send an end marker (for example, an end marker) to the first base station, so as to terminate a connection, corresponding to the UE, between the first base station and the target gateway. To be specific, after the UE is handed over from the first base station to the second base station, the connection related to the UE on a first base station side may terminate, so as to release the resource.

In this example, when receiving uplink data packets sent by the UE on the two paths, and determining that 5-tuples of the uplink data packets on the two paths are the same, the target gateway may determine that the base station is switched.

Optional solution 2: A solution related to a dedicated bearer between a packet gateway (for example, the first packet gateway) and a target gateway (for example, the first target gateway).

In an example, the packet gateway may establish the dedicated bearer with the target gateway. For example, the packet gateway receives a dedicated bearer establishment request sent by the target gateway, and the dedicated bearer establishment request is used to request to establish a first dedicated bearer, corresponding to UE, between the target gateway and the packet gateway. The packet gateway establishes the first dedicated bearer based on the dedicated bearer establishment request, and the packet gateway determines a second dedicated bearer between the packet gateway and the UE.

In this example, the first dedicated bearer is established between the packet gateway and the target gateway, and the second dedicated bearer between the packet gateway and the UE is determined, so as to transmit a resource by using the first dedicated bearer and the second dedicated bearer, thereby meeting a requirement for transmitting different QoS services.

It should be understood that, a default bearer and the dedicated bearer may exist on a PDN connection. The default bearer is a bearer that meets default QoS data and signaling. The dedicated bearer is a bearer that is established, based on the PDN connection, to provide a specific QoS transmission requirement (for example, a service-related QoS requirement). Generally, the dedicated bearer has a higher QoS requirement than the default bearer.

The first dedicated bearer may be a dedicated bearer that is established, between the packet gateway and the target gateway, to transmit data with a higher QoS requirement. For example, when a resource with a relatively high QoS requirement such as video data needs to be transmitted between the packet gateway and the target gateway, the packet gateway and the target gateway may establish a dedicated bearer used to transmit the video data.

It should be understood that the second dedicated bearer between the packet gateway and the UE is a dedicated bearer between the packet gateway and the UE, and the resource is transmitted between the UE and the target gateway by using the first dedicated bearer and the second dedicated bearer. The second dedicated bearer may include a dedicated bearer between the packet gateway and a serving gateway, a dedicated bearer between the serving gateway and the base station, and a dedicated radio bearer between the base station and the UE.

In a possible manner, the determining, by the packet gateway, a second dedicated bearer between the packet gateway and the UE includes: determining, by the packet gateway, that there is a dedicated bearer between the packet gateway and the UE, and determining the dedicated bearer as the second dedicated bearer; or determining, by the packet gateway, that there is no dedicated bearer between the packet gateway and the UE, and establishing the second dedicated bearer.

In this example, when determining that there is the dedicated bearer between the packet gateway and the UE, the packet gateway does not need to establish the second dedicated bearer, and determines the dedicated bearer as the second dedicated bearer. The second dedicated bearer may be reused, so as to save network resources.

For example, in the prior art, the packet gateway usually establishes the first dedicated bearer corresponding to the UE with only one gateway. For example, in the prior art, after the packet gateway establishes the first dedicated bearer with a PGW2, the packet gateway needs to establish the second dedicated bearer with the UE, so as to establish a dedicated bearer between the UE and the PGW2. In this embodiment of the present invention, when the packet gateway receives a first dedicated bearer request of the PGW2, the packet gateway may establish the first dedicated bearer with another gateway. This indicates that a dedicated bearer has been established between the packet gateway and the UE. In this case, the packet gateway does not need to establish the second dedicated bearer, but only needs to determine the existing dedicated bearer between the packet gateway and the UE as the second dedicated bearer. The resource accessed by the UE is transmitted by using the first dedicated bearer and the second dedicated bearer. When there is no dedicated bearer between the packet gateway and the UE, the packet gateway establishes the second dedicated bearer, so as to save network resources, and improve resource access efficiency of the UE.

In another example, the packet gateway may further receive a dedicated bearer modification request sent by the target gateway, and the dedicated bearer modification request is used to request to modify a first dedicated bearer. The packet gateway modifies the first dedicated bearer based on the dedicated bearer modification request. The packet gateway determines that there is a dedicated bearer, corresponding to UE, between the packet gateway and another gateway other than the target gateway, and the packet gateway establishes a new dedicated bearer between the packet gateway and the UE. Optionally, when the packet gateway determines that there is no dedicated bearer, corresponding to the UE, between the packet gateway and the another gateway other than the target gateway, the packet gateway modifies a second dedicated bearer based on the dedicated deletion bearer request.

In this example, when modifying the first dedicated bearer with the target gateway, the packet gateway determines that there is the dedicated bearer, corresponding to the UE, between the packet gateway and the another gateway other than the target gateway, in other words, the target gateway shares the second dedicated bearer with the another gateway, and the packet gateway establishes the new dedicated bearer between the packet gateway and the UE, so as to ensure communication of the dedicated bearer between the UE and the another gateway, and improve resource access efficiency.

It should be understood that in this example, after receiving the dedicated bearer modification request of the target gateway, the packet gateway needs to modify the first dedicated bearer between the packet gateway and the target gateway, and modify the second dedicated bearer between the packet gateway and the UE. In this case, the packet gateway further needs to determine whether there is another gateway sharing the second dedicated bearer with the target gateway, or the packet gateway further needs to determine whether there is the dedicated bearer, corresponding to the UE, between the packet gateway and the another gateway other than the target gateway. When there is the dedicated bearer, the packet gateway needs to establish the new dedicated bearer between the packet gateway and the UE, in other words, the target gateway transmits data by using the newly established dedicated bearer, and the another gateway transmits data by using the second dedicated bearer, so as to ensure normal communication of the dedicated bearer between the UE and the another gateway.

In still another example, the packet gateway may further receive a dedicated bearer deletion request sent by the target gateway, and the dedicated bearer deletion request is used to request to delete a first dedicated bearer. The packet gateway deletes the first dedicated bearer based on the dedicated bearer deletion request. The packet gateway determines that there is no dedicated bearer, corresponding to UE, between the packet gateway and another gateway other than the target gateway, and deletes a second dedicated bearer.

In this example, when deleting the first dedicated bearer with the target gateway, the packet gateway determines whether there is the dedicated bearer, corresponding to the UE, between the packet gateway and the another gateway. When there is the dedicated bearer, the packet gateway does not delete a dedicated bearer between the packet gateway and the UE, so as to ensure normal communication of the dedicated bearer between the UE and the another gateway.

It should be understood that in this example, after receiving the dedicated bearer deletion request of the target gateway, the packet gateway needs to delete the first dedicated bearer between the packet gateway and the target gateway, and determines whether to delete the second dedicated bearer between the packet gateway and the UE. In this case, the packet gateway further needs to determine whether there is another gateway sharing the second dedicated bearer with the target gateway, or the packet gateway further needs to determine whether there is the dedicated bearer, corresponding to the UE, between the packet gateway and the another gateway other than the target gateway. When there is the dedicated bearer, the packet gateway does not delete the second dedicated bearer. When there is no dedicated bearer, corresponding to the UE, between the packet gateway and the another gateway, the packet gateway deletes the second dedicated bearer, so as to ensure normal communication of the dedicated bearer between the UE and the another gateway.

The following further describes the solution in this embodiment of the present invention with reference to more accompanying drawings.

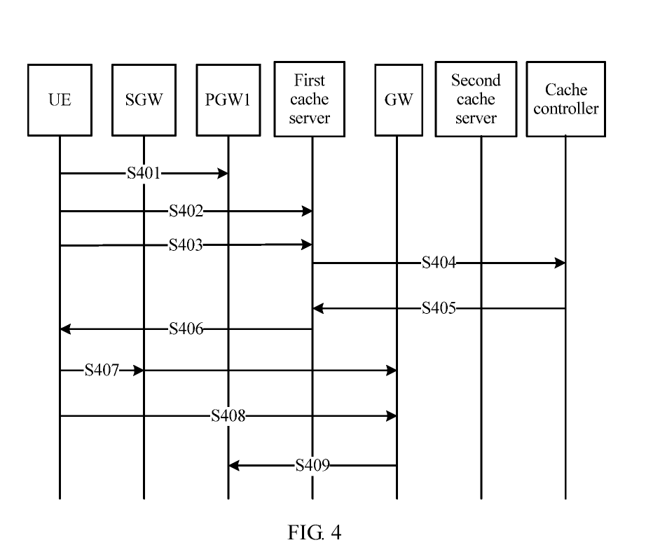

FIG. 4 shows another resource access method according to an embodiment of the present invention. As shown in FIG. 4, a first packet gateway may be a PGW, a first cache server may be a local cache server corresponding to the PGW, and a second cache server may be the target server, in other words, the second cache server stores a resource accessed by user equipment. A GW may be the target gateway, in other words, the GW is a gateway corresponding to the second cache server. A cache controller may be configured to schedule and control all cache servers in a distributed cache system.

As shown in FIG. 4, the resource access method may include the following steps.

S401. A PDN connection is established between UE and a PGW1.

S402. The UE establishes a first TCP connection to a first cache server through the PGW1.

S403. The UE sends a first HTTP request packet to the first cache server through the PGW1, where the first HTTP request packet is used to request to access a resource.

S404. The first cache server performs local cache query, and sends a query message to a cache controller if no local cache is hit.

S405. After receiving the query message, the cache controller performs cache hit query in a distributed cache range, and after determining that the resource is stored in a second cache server, feeds back an IP address of the second cache server to the first cache server.

S406. The first cache server notifies the UE of the IP address of the second cache server by using an HTTP redirection message, so that the UE resends a second TCP establishment request packet to the second cache server based on the IP address of the second cache server.

S407. A base station receives the second TCP establishment request packet sent by the UE, where the second TCP establishment request packet includes the IP address of the second cache server. The base station determines an IP address of a GW based on the IP address of the second cache server, and locally queries whether there is a corresponding tunnel. If there is a corresponding tunnel, a TCP connection to the second cache server is established through a tunnel between the base station and the GW; or if there is no corresponding tunnel, a tunnel between the base station and the GW is established, and then a TCP connection to the second cache server is established.

For example, a tunnel may be established or selected based on address information of the GW and QoS information carried in a UE service.

S408. The base station receives a second HTTP request packet sent by the UE, where the second HTTP request packet is used to request to access a resource from the second cache server, and the base station transmits the second HTTP request packet through the tunnel between the base station and the GW. The GW transmits the resource accessed by the UE to the base station through the tunnel.

S409. The GW sends, to the PGW1, charging information that is generated when the UE accesses the second cache server, so that the PGW1 performs charging.

In this embodiment of the present invention, the base station parses an IP packet sent by the user equipment, and then determines an IP address of a target server, so as to determine a target gateway based on the IP address of the target server, establish a target tunnel between the base station and the target gateway, and transmit a resource through the target tunnel, thereby improving resource access efficiency. The charging information generated when the UE accesses the resource is sent by the target gateway to the first packet gateway for charging, so that a function of the target gateway is simplified, and network resources are saved.

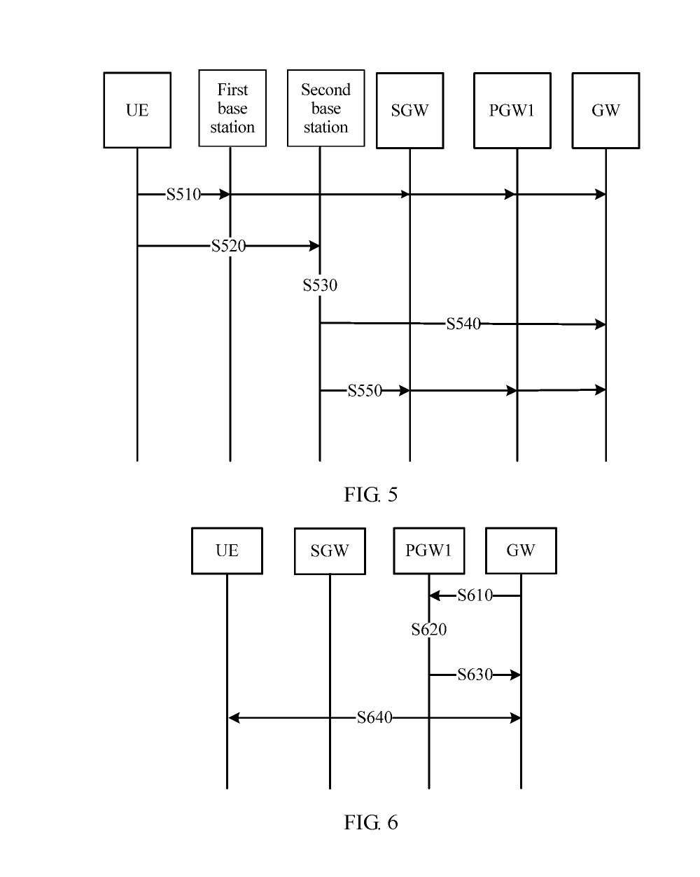

FIG. 5 shows still another resource access method according to an embodiment of the present invention. In the method shown in FIG. 5, a base station connected to UE is switched from a first base station to a second base station, or a first base station may be referred to as a source base station, and a second base station may be referred to as a target base station. The first base station establishes a bearer with each of an SGW and a PGW1, and there is a target tunnel between the first base station and a GW.

As shown in FIG. 5, the resource access method may include the following steps.

S510. UE communicates with a GW through a first base station, where there is a bearer between the UE and a PGW 1 through the first base station and an SGW, and there is a tunnel between the first base station and the GW.

S520. The UE moves to a coverage edge of the first base station, to make preparations for handover, and the UE sends an uplink data packet to the GW through a second base station.

S530. After receiving the uplink data packet sent by the UE, the second base station determines whether the second base station supports establishment of a tunnel with the GW.

S540. When the second base station supports establishment of the tunnel with the GW, the second base station selects or establishes the tunnel between the second base station and the GW, and sends the uplink data packet to the GW through the tunnel.

In this step, when the GW determines to receive the uplink data packet of the UE from the two paths (namely, the tunnel between the first base station and the GW and the tunnel between the second base station and the GW), it may be determined, based on a same 5-tuple of the uplink data packets, that the UE is handed over from the first base station to the second base station. The GW may send downlink data to the UE through the tunnel between the second base station and the GW.

S550. When the second base station does not support establishment of the tunnel with the GW, the second base station forwards the uplink data packet to the SGW, and the uplink data packet is transmitted to the GW through the PGW1.

In this step, when the GW determines to receive the uplink data packet of the UE on two paths (namely, the tunnel between the first base station and the GW and a bearer between the second base station and each of the SGW, a PGW, and the GW), it may be determined, based on a same 5-tuple of the uplink data packets, that the UE is handed over from the first base station to the second base station. The GW may send downlink data to the UE by using the bearer between the second base station and each of the SGW, the PGW, and the GW.

Optionally, in S540 or S550, after determining that the base station is switched, the GW may send an end marker (for example, an end marker) to the first base station, so as to terminate a connection between the first base station and the GW.

In this embodiment of the present invention, as the target base station to which the UE is to be handed over, the second base station determines, after receiving uplink data sent by the UE to a target gateway, whether establishment of a tunnel is supported between the second base station and the target gateway, and determines, based on a determining result, whether a tunnel is established between the base station and the target gateway. When simultaneously receiving uplink data sent by the UE on the two paths, the target gateway determines that 5-tuples of uplink data packets on the two paths are the same, and determines that the base station is switched.

The foregoing describes in detail the solution provided in the embodiments of the present invention with reference to FIG. 1 to FIG. 5. On this basis, based on different QoS level requirements of services, the UE may further establish a dedicated bearer with the target gateway, and access a resource by using the dedicated bearer. The following describes a dedicated bearer establishment, modification, and deletion method with reference to FIG. 6 to FIG. 8. In the method shown in FIG. 6 to FIG. 8, there is a default bearer, corresponding to UE, between a base station and a PGW1 through an SGW, and there is a target tunnel, corresponding to the UE, between the base station and a target gateway.

FIG. 6 is a schematic diagram of communication of a dedicated bearer establishment method according to an embodiment of the present invention. As shown in FIG. 6, a target gateway may be a GW, a first packet gateway may be a PGW1, and a serving gateway may be an SGW. A method for establishing a dedicated bearer includes the following steps.

S610. A PGW1 receives a dedicated bearer establishment request sent by a GW, where the dedicated bearer establishment request is used to request to establish a first dedicated bearer between the PGW1 and the GW.

S620. The PGW1 determines whether there is a dedicated bearer between the PGW1 and UE.

S630. When there is the dedicated bearer, the PGW1 determines the dedicated bearer as a second dedicated bearer between the PGW1 and the UE, and establishes the first dedicated bearer between the PGW1 and the GW. After establishing the first dedicated bearer, the PGW1 sends a dedicated bearer establishment response message to the GW, where the dedicated bearer establishment response message includes parameter information (for example, an ID identifier of a bearer) of the first dedicated bearer and the second dedicated bearer.

S640. When there is no dedicated bearer, the PGW1 establishes the first dedicated bearer between the PGW1 and the GW, and establishes the second dedicated bearer between the PGW1 and the UE. After establishing the first dedicated bearer, the PGW1 sends the dedicated bearer establishment response message to the GW.

In this embodiment of the present invention, when the target gateway requests the first packet gateway to establish a dedicated bearer, the first packet gateway determines whether there is a dedicated bearer between the first packet gateway and the UE. When there is the dedicated bearer, the dedicated bearer is determined as a second dedicated bearer between the first packet gateway and the UE. Only a first dedicated bearer between the first packet gateway and the target gateway is established, and a resource accessed by the UE is transmitted by using the first dedicated bearer and the second dedicated bearer, so as to save network resources, and improve resource access efficiency of the UE.

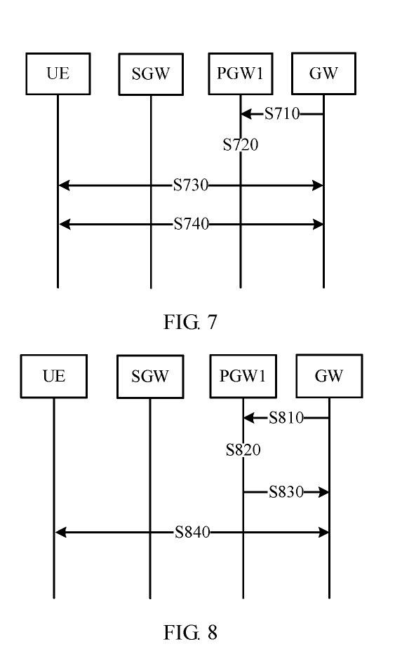

FIG. 7 is a schematic diagram of communication of a dedicated bearer modification method. As shown in FIG. 7, in the method shown in FIG. 7, for content that is the same as or similar to that shown in FIG. 6, refer to the related description in FIG. 6. Details are not described herein again. The dedicated bearer modification method includes the following steps.

S710. A PGW1 receives a dedicated bearer modification request sent by a GW, where the dedicated bearer modification request is used to request to establish a first dedicated bearer between the PGW1 and the GW.

S720. The PGW1 determines whether there is a dedicated bearer, corresponding to UE, between the PGW1 and another gateway other than the GW.

S730. When there is the dedicated bearer between the PGW1 and the another gateway other than the GW, the PGW1 establishes a new dedicated bearer between UE and the PGW1, modifies a dedicated bearer between the GW and the PGW1, and returns a dedicated bearer modification response message to the GW.

When there is the dedicated bearer, it indicates that the another gateway and the GW share a second dedicated bearer between the PGW1 and the UE. If the second dedicated bearer is modified, communication between the UE and the another gateway is affected. In this step, a new dedicated bearer between the UE and the PGW1 is established, so as to maintain communication between the UE and the another gateway.

S740. When there is no dedicated bearer between the PGW1 and the another gateway other than the GW, the PGW1 modifies a dedicated bearer between the GW and the UE and a bearer between the PGW1 and the UE, and sends the dedicated bearer modification response message to the GW.

In this embodiment of the present invention, when the target gateway requests the first packet gateway to modify the dedicated bearer, the first packet gateway determines whether there is a dedicated bearer, corresponding to the UE, between the first packet gateway and the another gateway. When there is the dedicated bearer between the first packet gateway and the another gateway, a new dedicated bearer between the first packet gateway and the UE is established, so as to ensure communication between the first packet gateway and the another gateway, and improve resource access efficiency.

For example, FIG. 8 is a schematic diagram of communication of a dedicated bearer deletion method. In the method shown in FIG. 8, for content that is the same as or similar to that shown in FIG. 6 or FIG. 7, refer to the related description in FIG. 6 or FIG. 7. Details are not described herein again. As shown in FIG. 8, the dedicated bearer deletion method includes the following steps.

S810. A PGW1 receives a dedicated bearer deletion request sent by a GW.

S820. The PGW1 determines whether there is a first dedicated bearer, corresponding to UE, between the PGW1 and another gateway other than the GW.

S830. When there is a dedicated bearer between the PGW1 and another PGW, the PGW1 deletes a dedicated bearer between the PGW1 and the GW, and does not delete a second dedicated bearer between the PGW1 and the UE.

S840. When there is no dedicated bearer between the PGW1 and another PGW, the PGW1 deletes a dedicated bearer between the PGW1 and the GW, and deletes the second dedicated bearer between the PGW1 and the UE.

In this embodiment of the present invention, when the target gateway requests the first packet gateway to delete the dedicated bearer, the first packet gateway determines whether there is a dedicated bearer, corresponding to the UE, between the first packet gateway and the another gateway. When there is the dedicated bearer between the first packet gateway and the another gateway, only a dedicated bearer between the first packet gateway and the target gateway is deleted, and a second dedicated bearer between the first packet gateway and the UE and a dedicated bearer between the first packet gateway and the another gateway are maintained, so as to ensure communication between the first packet gateway and the another gateway, and improve resource access efficiency.

It should be noted that, when the solution provided in this embodiment of the present invention is applied to different system architectures, a serving gateway may be an SGW or an SGSN, and a first packet gateway may be a PGW or a GGSN. For example, when a system architecture shown in FIG. 2 is applied, the first packet gateway is the SGW, and the packet gateway is the PGW.

The foregoing mainly describes the solutions in the embodiments of the present invention from the perspective of interaction between network elements. It may be understood that, to implement the foregoing functions, each network element such as the base station, the target gateway, or the first packet gateway includes a corresponding hardware structure and/or software module for performing each function. A person of ordinary skill in the art should be easily aware that, the units and algorithm steps in the examples described with reference to the embodiments disclosed in this specification may be implemented by hardware or a combination of hardware and computer software. Whether the functions are performed by hardware or computer software driving hardware depends on particular applications and design constraint conditions of the technical solutions. A person skilled in the art may use different methods to implement the described functions for each particular application, but it should not be considered that the implementation goes beyond the scope of the present invention.

In the embodiments of the present invention, functional unit division may be performed on the base station, the target gateway, the packet gateway (for example, the first packet gateway), and the like based on the foregoing method examples. For example, each functional unit may be divided based on each function, or two or more functions may be integrated into one processing unit. The integrated unit may be implemented in a form of hardware, or may be implemented in a form of a software functional unit. It should be noted that the unit division in the embodiments of the present invention is an example, and is merely logical function division. There may be another division manner in an actual implementation.

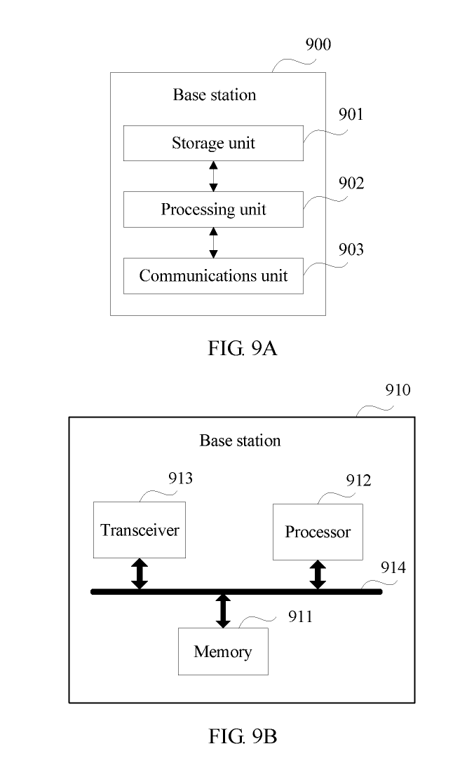

When an integrated unit is used, FIG. 9A is a possible schematic structural diagram of the base station in the foregoing embodiments. A base station 900 includes a processing unit 902 and a communications unit 903. The processing unit 902 is configured to control and manage an action of the base station. For example, the processing unit 902 is configured to support the base station in performing the processes S310 to S340 in FIG. 3, the processes S407 and S408 in FIG. 4, the processes S510 to S550 in FIG. 5, and/or another process of the technology described in this specification. The communications unit 903 is configured to support the base station in communicating with another network entity, for example, communicating with the serving gateway, the gateway, or the PGW shown in FIG. 2. The base station may further include a storage unit 901, configured to store program code and data of the base station.

The processing unit 902 may be a processor or a controller, for example, may be a central processing unit (Central Processing Unit, CPU), a general-purpose processor, a digital signal processor (Digital Signal Processor, DSP), an application-specific integrated circuit (Application-Specific Integrated Circuit, ASIC), a field programmable gate array (Field Programmable Gate Array, FPGA) or another programmable logic device, a transistor logic device, a hardware component, or any combination thereof. The processing unit 902 may implement or execute various example logical blocks, modules, and circuits that are described with reference to the content disclosed in the present invention. The processor may also be a combination of computing functions, for example, a combination of one or more microprocessors or a combination of a DSP and a microprocessor. The communications unit 903 may be a transceiver, a transceiver circuit, a communications interface, or the like. The storage unit 901 may be a memory.

When the processing unit 902 is a processor, the communications unit 903 is a transceiver, and the storage unit 901 is a memory, the base station in this embodiment of the present invention may be a base station shown in FIG. 9B.

As shown in FIG. 9B, the base station 910 includes a processor 912, a transceiver 913, and a memory 911. Optionally, the base station 910 may further include a bus 914. The transceiver 913, the processor 912, and the memory 911 may be connected by using the bus 914. The bus 914 may be a peripheral component interconnect (Peripheral Component Interconnect, PCI for short) bus or an extended industry standard architecture (Extended Industry Standard Architecture, EISA for short) bus, or the like. The bus 914 may be classified into an address bus, a data bus, a control bus, or the like. For ease of indication, the bus is indicated by using only one bold line in FIG. 9B. However, it does not indicate that there is only one bus or only one type of bus.

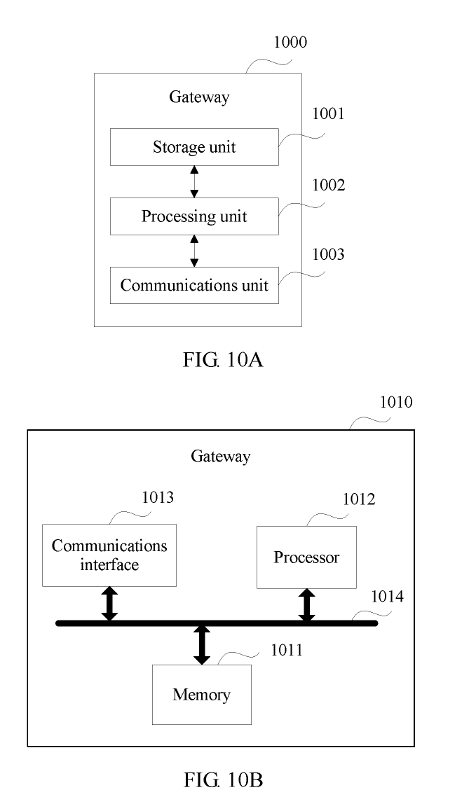

When an integrated unit is used, FIG. 10A is a possible schematic structural diagram of the gateway in the foregoing embodiments. The gateway may be the foregoing target gateway, and a gateway 1000 includes a processing unit 1002 and a communications unit 1003. The processing unit 1002 is configured to control and manage an action of the gateway. For example, the processing unit 1002 is configured to support the gateway in performing the processes S330 to S350 in FIG. 3, the processes S407 to S409 in FIG. 4, the processes S510, S520, S540, and S550 in FIG. 5, the processes S610 to S640 in FIG. 6, the processes S710 to S740 in FIG. 7, the processes S810 to S840 in FIG. 8, and/or another process of a technology described in this specification. The communications unit 1003 is configured to support the gateway in communicating with another network entity, for example, communicating with the base station, the MME, or the PGW shown in FIG. 2. The gateway may further include a storage unit 1001, configured to store program code and data of the gateway.

The processing unit 1002 may be a processor or a controller, for example, may be a central processing unit (Central Processing Unit, CPU), a general-purpose processor, a digital signal processor (Digital Signal Processor, DSP), an application-specific integrated circuit (Application-Specific Integrated Circuit, ASIC), a field programmable gate array (Field Programmable Gate Array, FPGA) or another programmable logic device, a transistor logic device, a hardware component, or any combination thereof. The processing unit 1002 may implement or execute various example logical blocks, modules, and circuits that are described with reference to the content disclosed in the present invention. The processor may also be a combination of computing functions, for example, a combination of one or more microprocessors or a combination of a DSP and a microprocessor. The communications unit 1003 may be a communications interface, a transceiver, a transceiver circuit, or the like. The communications interface is a general term. In specific implementation, the communications interface may include one or more interfaces. The storage unit 1001 may be a memory.

When the processing unit 1002 is a processor, the communications unit 1003 is a communications interface, and the storage unit 1001 is a memory, the gateway in this embodiment of the present invention may be a gateway shown in FIG. 10B.

As shown in FIG. 10B, the gateway 1010 includes a processor 1012, a communications interface 1013, and a memory 1011. Optionally, the gateway 1010 may further include a bus 1014. The communications interface 1013, the processor 1012, and the memory 1011 may be connected by using the bus 1014. The bus 1014 may be a peripheral component interconnect (Peripheral Component Interconnect, PCI for short) bus or an extended industry standard architecture (Extended Industry Standard Architecture, EISA for short) bus, or the like. The bus 1014 may be classified into an address bus, a data bus, a control bus, or the like. For ease of indication, the bus is indicated by using only one bold line in FIG. 10B. However, it does not indicate that there is only one bus or only one type of bus.

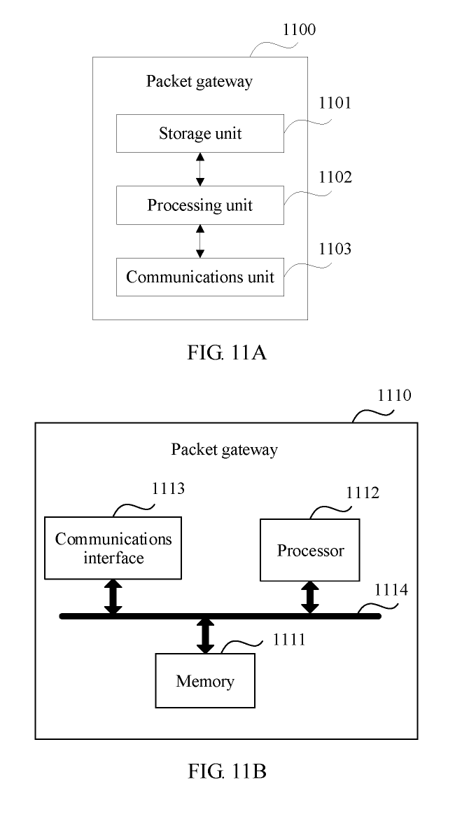

When an integrated unit is used, FIG. 11A is a possible schematic structural diagram of the packet gateway in the foregoing embodiments. The gateway may be the foregoing first packet gateway, and a packet gateway 1100 includes a processing unit 1102 and a communications unit 1103. The processing unit 1102 is configured to control and manage an action of the packet gateway. For example, the processing unit 1102 is configured to support the packet gateway in performing the process S310 in FIG. 3, the processes S401 to S403 and S409 in FIG. 4, the processes S510 and S550 in FIG. 5, the processes S610 to S640 in FIG. 6, the processes S710 to S740 in FIG. 7, the processes S810 to S840 in FIG. 8, and/or another process of a technology described in this specification. For brevity, repetitive descriptions are appropriately omitted.

When the processing unit 1102 is a processor, the communications unit 1103 is a communications interface, and the storage unit 1101 is a memory, the packet gateway in this embodiment of the present invention may be a packet gateway shown in FIG. 11B.

As shown in FIG. 11B, the packet gateway 1110 includes a processor 1112, a communications interface 1113, and a memory 1111. Optionally, the packet gateway 1110 may further include a bus 1114. For brevity, repetitive descriptions are omitted.

The processor configured to perform the foregoing functions of the base station, the gateway, or the packet gateway in the embodiments of the present invention may be a central processing unit (Central Processing Unit, CPU), a general-purpose processor, a digital signal processor (Digital Signal Processor, DSP), an application-specific integrated circuit (Application-Specific Integrated Circuit, ASIC), a field programmable gate array (Field-Programmable Gate Array, FPGA) or another programmable logic device, a transistor logic device, a hardware component, or any combination thereof. The processor may implement or execute various example logical blocks, modules, and circuits that are described with reference to the content disclosed in the embodiments of the present invention. The processor may also be a combination of computing functions, for example, a combination of one or more microprocessors or a combination of a DSP and a microprocessor.

The methods or algorithm steps described with reference to the content disclosed in the embodiments of the present invention may be implemented in a hardware manner, or may be implemented in a manner of executing a software instruction by a processor. The software instruction may include a corresponding software module. The software module may be stored in a random access memory (Random Access Memory, RAM), a flash memory, a read-only memory (Read Only Memory, ROM), an erasable programmable read-only memory (Erasable Programmable ROM, EPROM), an electrically erasable programmable read-only memory (Electrically EPROM, EEPROM), a register, a hard disk, a removable hard disk, a compact disc read-only memory (CD-ROM), or a storage medium in any other forms well-known in the art. An example storage medium is coupled to the processor, so that the processor can read information from the storage medium, and can write information into the storage medium. Certainly, the storage medium may be a part of the processor. The processor and the storage medium may be located in an ASIC. In addition, the ASIC may be located in a gateway device or a mobility management network element. Certainly, the processor and the storage medium may exist in the gateway device or the mobility management network element as discrete components.

A person skilled in the art should be aware that in one or more of the foregoing examples, the functions described in the embodiments of the present invention may be implemented by using hardware, software, firmware, or any combination thereof. When these functions are implemented by software, these functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible to a general-purpose or dedicated computer.

The objectives, technical solutions, and beneficial effects of the embodiments of the present invention are further described in detail in the foregoing specific implementations. It should be understood that, the foregoing descriptions are only specific implementations of the embodiments of the present invention, but are not intended to limit the protection scope of the embodiments of the present invention. Any modification, equivalent replacement, or improvement made based on the technical solutions in the embodiments of the present invention shall fall within the protection scope of the embodiments of the present invention.

What is claimed is:

1. A resource access method, comprising:
receiving, by a base station, an Internet Protocol (IP) packet of first user equipment (UE), wherein the IP packet carries an IP address of a target server, the target server stores a resource to be accessed by the first UE, and there is a bearer, corresponding to the first UE, between the base station and a first packet gateway;
determining, by the base station based on the IP address, a first target gateway corresponding to the target server;
determining, by the base station, a first target tunnel between the base station and the first target gateway; and
sending, by the base station, an access request of the first UE to the first target gateway through the first target tunnel, wherein the access request is used to request to access the resource stored in the target server.

2. The method according to claim 1, wherein the determining, by the base station, a first target tunnel between the base station and the first target gateway comprises:
establishing, by the base station, the first target tunnel between the base station and the first target gateway; or
determining, by the base station, the first target tunnel from at least one existing tunnel, wherein the at least one existing tunnel is a tunnel, corresponding to the UE, between the base station and at least one gateway.

3. The method according to claim 1, wherein the method further comprises:
receiving, by the base station, uplink data sent by second UE to a second target gateway, wherein the base station is a target base station to which the second UE is to be handed over from a source base station, there is a tunnel, corresponding to the second UE, between the source base station and the second target gateway, and there is a bearer, corresponding to the second UE, between the source base station and a second packet gateway; and
when establishment of a tunnel is not supported between the base station and the second target gateway, transmitting, by the base station, the uplink data to the second target gateway through the second packet gateway; or
when establishment of a tunnel is supported between the base station and the second target gateway, determining, by the base station, a second target tunnel between the base station and the second target gateway, so that the uplink data is transmitted to the second target gateway through the second target tunnel.

4. The method according to claim 1, wherein the method further comprises:
receiving, by the base station, an end marker sent by the first target gateway, so as to terminate a connection, corresponding to the first UE, between the base station and the first target gateway.

5. A resource access method, comprising:
receiving, by a target gateway, an access request of user equipment UE that is sent by a first base station through a target tunnel, wherein the access request is used to request to access a resource stored in a target server corresponding to the target gateway, the target tunnel is a tunnel between the target gateway and the first base station, and there is a bearer, corresponding to the UE, between the first base station and a first packet gateway; and
transmitting, by the target gateway, the resource to the UE through the target tunnel.

6. The method according to claim 5, wherein the method further comprises:
receiving, by the target gateway, a first uplink data packet that is sent by the UE through the target tunnel;
receiving, by the target gateway, a second uplink data packet that is sent by the UE through a second base station;
when a 5-tuple of the first uplink data packet is the same as a 5-tuple of the second uplink data packet, determining, by the target gateway, that the UE is handed over from the first base station to the second base station; and
transmitting, by the target gateway, downlink data to the UE through a tunnel between the second base station and the target gateway; or
transmitting, by the target gateway, downlink data to the UE through the first packet gateway.

7. The method according to claim 5, wherein the method further comprises:
sending, by the target gateway, an end marker to the first base station, so as to terminate a connection, corresponding to the UE, between the first base station and the target gateway.

8. The method according to claim 5, wherein the method further comprises:
sending, by the target gateway to the first packet gateway, charging information that is generated when the UE accesses the resource, wherein the charging information is used by the first packet gateway to perform charging.

9. A base station, comprising a processor and a transceiver, wherein
the processor is configured to receive an Internet Protocol IP packet of first user equipment UE by using the transceiver, wherein the IP packet carries an IP address of a target server, the target server stores a resource to be accessed by the first UE, and there is a bearer, corresponding to the first UE, between the base station and a first packet gateway; and the processor is further configured to: determine, based on the IP address, a first target gateway corresponding to the target server; determine a first target tunnel between the base station and the first target gateway; and send an access request of the first UE to the first target gateway through the first target tunnel and the transceiver, wherein the access request is used to request to access the resource stored in the target server.

10. The base station according to claim 9, wherein the processor is specifically configured to establish, by using the transceiver, the first target tunnel between the base station and the first target gateway; or the processor is specifically configured to determine the first target tunnel from at least one existing tunnel, wherein the at least one existing tunnel is a tunnel, corresponding to the UE, between the base station and at least one gateway.

11. The base station according to claim 9, wherein the processor is specifically configured to: receive, by using the transceiver, uplink data sent by second UE to a second target gateway, wherein the base station is a target base station to which the second UE is to be handed over from a source base station, there is a tunnel, corresponding to the second UE, between the source base station and the second target gateway, and there is a bearer, corresponding to the second UE, between the source base station and a second packet gateway; and when establishment of a tunnel is not supported between the base station and the second target gateway, transmit, by using the transceiver, the uplink data to the second target gateway through the second packet gateway; or when establishment of a tunnel is supported between the base station and the second target gateway, determine a second target tunnel between the base station and the second target gateway, so that the uplink data is transmitted to the second target gateway through the second target tunnel.

12. The base station according to claim 9, wherein the processor is further configured to receive, by using the transceiver, an end marker sent by the first target gateway, so as to terminate a connection, corresponding to the first UE, between the base station and the first target gateway.
